(19) United States
(12) Patent Application Publication
(10) Pub. No.: US 2026/0217170 A1
(43) Pub. Date: Jul. 30, 2026

(54) VEHICLE HEADREST COVER AND RETAINER SYSTEM

(71) Applicant: Toyota Boshoku America, Inc., Novi, MI (US)

(72) Inventors: Alban Shavers, Novi, MI (US); Brian Cobus, Novi, MI (US); Duane McClusky, Novi, MI (US)

(73) Assignee: Toyota Boshoku America, Inc., Novi, MI (US)

(21) Appl. No.: 19/459,022

(22) Filed: Jan. 26, 2026

Related U.S. Application Data
(60) Provisional application No. 63/749,768, filed on Jan. 27, 2025.

(51) Int. Cl. B60N 2/60

(52) U.S. Cl. CPC B60N 2/6027

(57) ABSTRACT

A vehicle headrest cover is provided that includes a frame member having an outer surface, a back wall, a shelf, and a posts protruding from the shelf. The frame member is configured to engage with at least one headrest of a vehicle. A fabric portion having a first end and a second end is configured to cover the outer surface of the frame member. A first retainer is attached to the first end of the fabric portion and defines through holes that are configured to engage with the posts of the frame member. A second retainer is attached to the second end of the fabric portion, the second retainer defining through holes that are configured to engage with the posts of the frame member.

### RELATED APPLICATIONS

This application is a non-provisional application that claims priority benefit of U.S. Provisional Application Ser. No. 63/749,768, filed Jan. 27, 2025, the contents of which are hereby incorporated by reference.

### FIELD OF THE INVENTION

The present invention relates to a vehicle headrest cover, and more particularly to a vehicle headrest cover and retainer system.

### BACKGROUND OF THE INVENTION

In general, a headrest is designed to be installed on vehicle seats, particularly the driver's seat and the passenger's seat of the vehicle, to support the head of seat occupants so that the head can be rested while preventing the head from being tilted back and forth in sudden unintended accelerations or accidents.

In a conventional headrest, such as that shown in FIG. 1, the headrest 10 is manufactured by inserting or injecting a flexible polyurethane, which is a foam material excellent in cushioning property, into a skin material sewn using a fabric having air permeability. Such a headrest is made by sewing the skin material by using the fabric in a shape the same as that of the headrest, inserting a stay frame into the headrest, the stay frame having a finishing material for finishing a lower end portion of the headrest, and then injecting the flexible polyurethane foaming liquid into the skin material through an injection port at a center of the finishing material. The urethane foaming liquid injected into the skin material hardens after a certain period of time, thereby forming the shape of the headrest. The posts 18 of the stay frame are configured to be inserted into corresponding stay holes in the top of the vehicle seat back in order to retain the headrest 10 on the seat back.

Additionally, ever since the introduction of the headrest portion of a seat on transportation vehicle seats, and more recently on cinema theaters, the issue of the headrest becoming soiled and potentially contaminated by constant contact with one or multiple occupants has been a concern to respective industries, health agencies, and the informed general public. This concern is especially acute on long transit transportation and cinema theaters where the seat occupants constantly rub their scalps against the headrest while assuming a more relaxed position. Such continuous contact with the headrest results in it quickly becoming soiled, creating a potentially unsanitary surface, which may act as a conduit to transfer contaminants to subsequent occupants.

Attempts have been made to create headrest covers for hygiene that can be placed on such high traffic headrests, however such covers are easily misaligned or torn, resulting in poor performance. Furthermore, such disposable covers tend to degrade the aesthetic appearance of the headrest.

Thus, there exists a need for a resilient headrest cover that is easily attached to a headrest and maintains its position relative thereto, while being aesthetically appealing and even enhancing the aesthetic appeal of the headrest and providing customization to the look of the headrest.

### SUMMARY OF THE INVENTION

A vehicle headrest cover is provided that includes a frame member having an outer surface, a back wall, a shelf, and a posts protruding from the shelf. The frame member is configured to engage with at least one headrest of a vehicle. A fabric portion having a first end and a second end is configured to cover the outer surface of the frame member. A first retainer is attached to the first end of the fabric portion and defines through holes that are configured to engage with the posts of the frame member. A second retainer is attached to the second end of the fabric portion, the second retainer defining through holes that are configured to engage with the posts of the frame member.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a perspective view of an existing headrest;

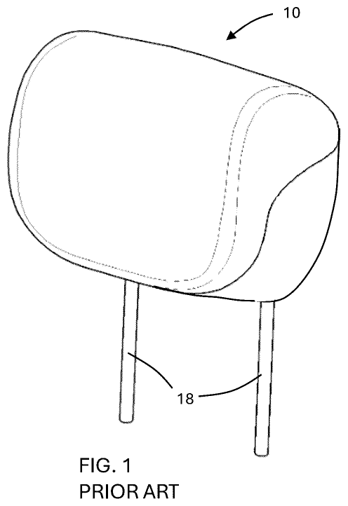

FIG. 2 shows a perspective view of a headrest cover system according to embodiments, installed on two vehicle headrests;

FIG. 3 shows a fabric portion with retainers of a headrest cover system according to embodiments of the present invention;

FIG. 4 shows a fabric portion with retainers of a headrest cover system according to embodiments of the present invention;

FIGS. 5A-5D show embodiments of a retainer according to embodiments of the present invention;

FIG. 6 shows a fabric portion with retainers of a headrest cover system according to embodiments of the present invention;

FIG. 7 shows a cross sectional view of a portion of a frame member of a headrest cover system according to embodiments of the present invention;

FIG. 8 shows a cross sectional view of a portion of a frame member covered with a fabric portion according to embodiments of the present invention; and

FIG. 9 shows a cross sectional view of a headrest cover system according to embodiments of the present invention.

### DESCRIPTION OF THE INVENTION

The present invention has utility as a resilient headrest cover that is easily attached to a headrest and maintains its position relative thereto, while being aesthetically appealing and enhancing the aesthetic appeal of the headrest and providing customization to the headrest, while also being easily removable for washing, repair, or replacement.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

The terminology used herein is for the purpose of describing particular example embodiments only and is not intended to be limiting. Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. Unless indicated otherwise, explicitly or by context, the following terms are used herein as set forth below.

As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

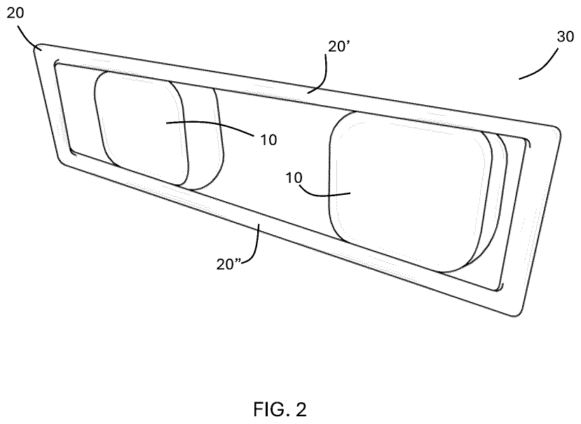

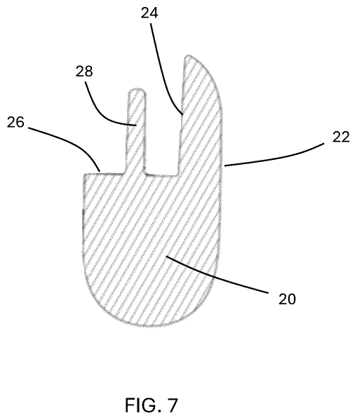

According to some inventive embodiments, as shown in FIG. 2, a vehicle headrest cover system 30 includes a frame member 20 that is configured to engage with at least one headrest 10 of the vehicle. According to other inventive embodiments, the frame member 20 forms an enclosed shape, such as a rectangle as shown in FIG. 2; however, any shape corresponding to the shape of the headrest 10 is suitable. According to still other inventive embodiments, the frame member 20 engages with the headrest by a friction fit, whereby the enclosed shape of the frame member 20 is fitted onto the at least one headrest. As shown in FIG. 7, the frame member 20 includes an outer surface 22, a back wall 24, a shelf 26, and a plurality of posts 28 protruding from the shelf 26. According to embodiments, the outer surface 22, back wall 24, shelf 26, and plurality of posts 28 are continuous along the entire length of the frame 20. As shown in FIG. 2, the frame member 20 can be considered to have a plurality of regions, such as a first region 20′ and a second region 20″, which correspond to an upper area and a lower area of the frame member, respectively.

The vehicle headrest cover system 30 additionally includes a fabric portion 32 having a first end 34 and a second end 36. A first retainer 40 is attached to the first end 34 of the fabric portion 32 and a second retainer 40′ is attached to the second end 36 of the fabric portion 32. Each retainer 40, 40′ defines a pair of through holes 42 that are configured to engage with a pair of posts 18 of a stay frame of a vehicle headrest 10 or vehicle seat. The fabric portion 32 of the cover 30 system is configured to cover the outer surface 22 of the frame member 20 with the retainers 40, 40′ configured to secure the ends 34, 36 of the fabric portion 32 to the posts 28 of the frame member 20.

According to other inventive embodiments, the fabric portion 32 is cloth such as fabrics, textile, genuine leather, synthetic leather, or the like. According to some embodiments, the fabric portion 32 is antimicrobial, breathable, moisture-absorbent fabric. According to still other inventive embodiments, the fabric portion 32 is a mesh fabric. According to other inventive embodiments, the fabric portion 32 is provided in any number of color options, thereby giving a user the ability to customize or decorate the vehicle headrest. According to some embodiments, the fabric portion 32 includes decorative indicia 38 thereon, thereby giving a user the ability to customize or decorate the vehicle headrest. For example, a brand sports logo can be placed on the fabric portion 32. According to still other inventive embodiments, the fabric portion 32 is disposable after a single use or once soiled, while according to other inventive embodiments the fabric portion 32 is washable and reusable.

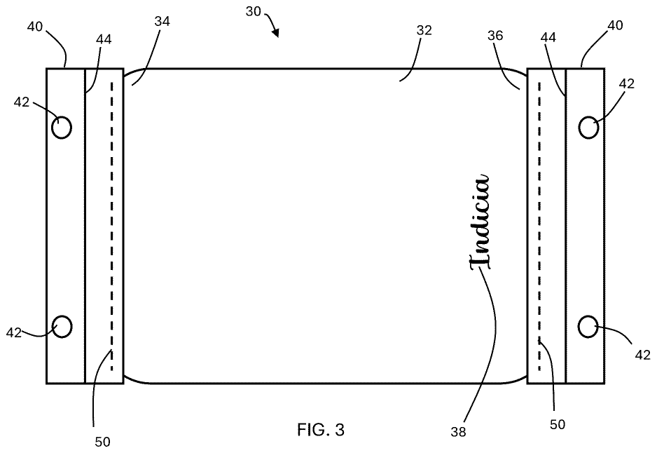

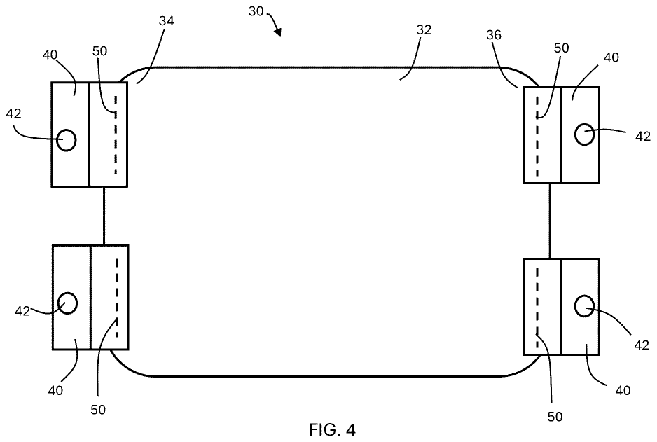

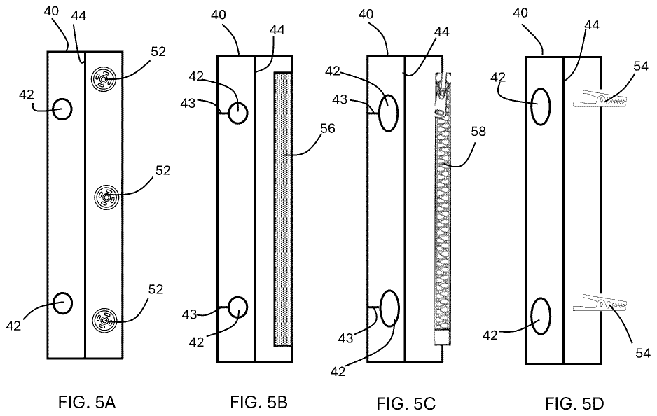

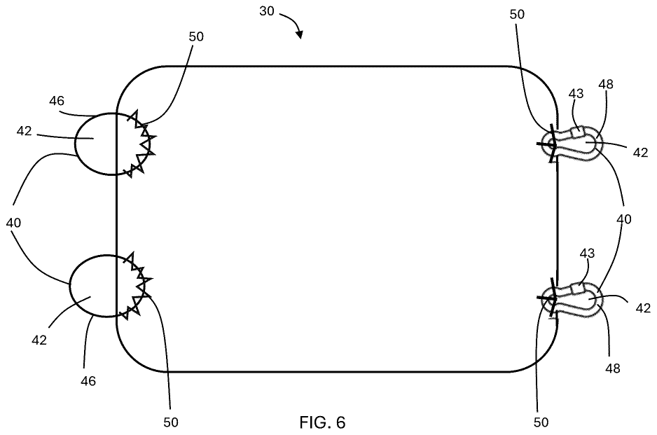

According to other inventive embodiments, the retainers 40, 40′ attached to the end 34, 36 of the fabric portion 32 are either continuous, as in FIGS. 3 and 5A-5D, or include separate portions, as in FIGS. 4 and 6. According to still other inventive embodiments, the retainers 40, 40′ are each independently a plate formed of thermoset, thermoplastic, wood, metal, or a combination thereof. According to such embodiments, the retainer 40, 40′ includes a score line 44 along which the plate 40, 40′ is configured to bend as it conforms to the frame member 20. According to still other embodiments, the retainers) 40, 40′ each include a pair of rings 46 or clamps 48, as shown in FIG. 6. It will be understood that any combination of retainers 40, 40′ can be used, not limited to the combinations shown in the figures.

Each retainer 40, 40′ defines a pair of through holes 42 that are configured to engage with the posts 28 of the frame member 20. As shown in FIGS. 3, 4, 5A, 5D, and the left-hand side of FIG. 6, the through holes 42 are fully closed holes. In contrast, the through holes 42 of FIGS. 5B, 5C, and the right-hand side of FIG. 6, are broken holes that allow the posts 28 to be slid within the through holes 42. The clamps 48 at the right-hand side of FIG. 6 are spring loaded clamps that are easily opened in order to place the posts 28 in the through holes 42 of the clamps 48. As for the retainers 40, 40′ shown in FIGS. 5B and 5C, a break 43 in the material of the retainer 40, 40′ connected to the through holes 42 allows the posts 28 to be passed through the breaks 43 and ultimately positioned within the through holes 42. As shown in the figures, the through holes 42 can have any suitable shape, for example, in FIGS. 3, 4, 5A, and 5B the through holes 42 are circular, while in FIGS. 5C and 5D the through holes 42 are ovals, thereby accommodating a greater variety of sizes of posts 28.

According to other inventive embodiments, the retainers 40, 40′ are attached to the ends 34, 36 of the fabric portion 32 by a plurality of stitches 50 or by an adhesive. According to still other inventive embodiments, the fabric portion 32 is removable from the retainers 40, 40′, for example by snaps 52, clamps 54, hook and loop fastener 56, or a zipper 58. In the case of snaps 52, hook and loop fastener 56, or a zipper 58, the ends 34, 36 of the fabric portion 32 include corresponding portions of the snaps, hook and loop fastener, or a zipper that engage with other half of those snaps, hook and loop fastener, or a zipper present on the retainer 40, 40′.

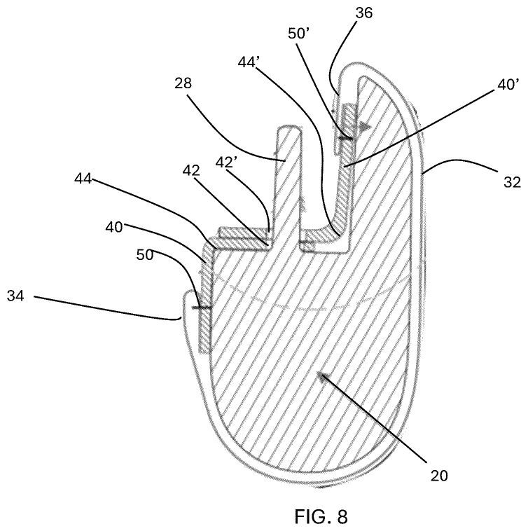

As shown in FIG. 8, is the fabric portion 32 is easily installed on to the frame member 20 by placing the posts 28 of the frame member 20 into the through holes 42 in a retainer 40 attached to the first end 34 of the fabric portion 32. The retainer 40 bends along the score line 44 and the fabric port 32 is wrapped over the outer surface 22 of the frame member 20. Next, the post 28 is placed into the through hole 42′ of a second retainer 40′ that is attached to the second end 36 of the fabric portion 32.

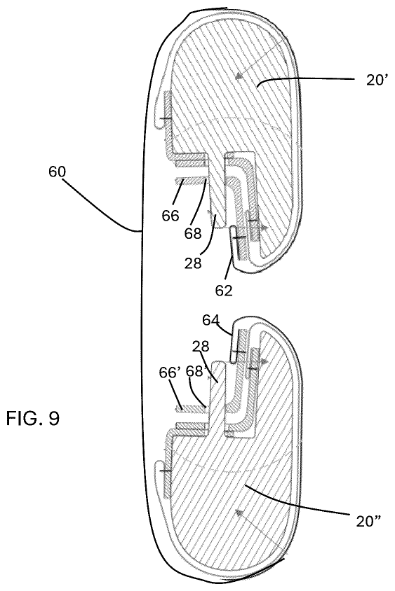

As shown in FIG. 9, a trim material 60 can be installed on the frame member 20 over the fabric portion 32. According to other inventive embodiments, the trim material 60 has a first end 62 and a second end 64 and a first trim retainer 66 attached to the first end 62 of the trim material 60. According to still other inventive embodiments, a second trim retainer 66′ is attached to the second end 64 of the trim material 60. Like the retainers 40, 40′ of the fabric portion 32, the trim retainer 66, 66′ defines a plurality of through holes 68 therein that are configured to engage with a subset of the plurality of posts 28 of the frame member 20. According to still other inventive embodiments, a first subset of the posts 28 of the frame 20 are positioned along a first region 20′ of the frame 20, for example the region of the frame that sits above the vehicle headrest 10 when the frame member 20 is installed thereon. A second subset of the posts 28 of the frame 20 are positioned along a second region 20″ of the frame 20, for example the region of the frame 20 that sits below the vehicle headrest 10 when the frame member 20 is installed thereon. Accordingly, when the first trim retainer 66 is installed on the first subset of the plurality of posts 28 of the frame 20 and the second trim retainer 66′ is installed on the second subset of the plurality of posts 28 of the frame 20, the trim material is configured to span the frame member 20 and cover the headrest 10 of the vehicle. According to some inventive embodiments, the trim material is a mesh material.

Patent documents and publications mentioned in the specification are indicative of the levels of those skilled in the art to which the invention pertains. These documents and publications are incorporated herein by reference to the same extent as if each individual document or publication is specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A vehicle headrest cover comprising:
a frame member having an outer surface, a back wall, a shelf, and a plurality of posts protruding from the shelf, the frame member configured to engage with at least one headrest of a vehicle;
a fabric portion having a first end and a second end, the fabric portion configured to cover the outer surface of the frame member; and
a first retainer attached to the first end of the fabric portion, the first retainer defining a plurality of through holes that are configured to engage with the plurality of posts of the frame member;
a second retainer attached to the second end of the fabric portion, the second retainer defining a plurality of through holes that are configured to engage with the plurality of posts of the frame member.

2. The vehicle headrest cover of claim 1 wherein the fabric portion is formed of cloth, fabric, textile, genuine leather, synthetic leather, antimicrobial material, mesh, moisture-absorbent fabric, or a combination thereof.

3. The vehicle headrest cover of claim 1 wherein the frame member is formed of a thermoplastic or thermoset material.

4. The vehicle headrest cover of claim 1 wherein the fabric portion includes decorative indicia.

5. The vehicle headrest cover of claim 1 wherein the fabric portion is removable from the first retainer.

6. The vehicle headrest cover of claim 1 wherein the fabric portion is disposable.

7. The vehicle headrest cover of claim 1 wherein the fabric portion is washable and reusable.

8. The vehicle headrest cover of claim 1 wherein the first retainer and the second retainer are each independently continuous or include separate portions.

9. The vehicle headrest cover of claim 1 wherein at least one of the first retainer and second retainer is a plate formed of thermoset, thermoplastic, wood, metal, or a combination thereof.

10. The vehicle headrest cover of claim 9 wherein the plate includes a score line along which the plate is configured to bend.

11. The vehicle headrest cover of claim 1 wherein at least one of the first retainer and second retainer is a pair of rings or clamps.

12. The vehicle headrest cover of claim 1 wherein the first retainer is attached to the first end of the fabric portion by a plurality of stitches, snaps, clamps or a combination thereof.

13. The vehicle headrest cover of claim 1 wherein the first retainer is attached to the first end of the fabric portion by a hook and loop fastener, a zipper, or an adhesive.

14. The vehicle headrest cover of claim 1 wherein the second retainer is attached to the second end of the fabric portion by a plurality of stitches, snaps, clamps or a combination thereof.

15. The vehicle headrest cover of claim 1 wherein the second retainer is attached to the second end of the fabric portion by a hook and loop fastener, a zipper, or an adhesive.

16. The vehicle headrest cover of claim 1 wherein the frame member forms an enclosed shape.

17. The vehicle headrest cover of claim 16 wherein the enclosed shape is a rectangle.

18. The vehicle headrest cover of claim 1 further comprising a trim material having a first end, a second end, and a first trim retainer attached to the first end of the trim material, the first trim retainer defining a plurality of through holes that are configured to engage with a first subset of the plurality of posts of the frame member, the first subset of posts being in a first region of the frame member.

19. The vehicle headrest cover of claim 18 further comprising a second trim retainer attached to the second end of the trim material, the second trim retainer defining a plurality of through holes that are configured to engage with a second subset of the plurality of posts of the frame member, the second subset of posts being in a second region of the frame member.

20. The vehicle headrest cover of claim 19 wherein the second region of the frame member is spaced apart from the first region of the frame member such that the trim material is configured to cover the at least one headrest of a vehicle when the first trim retainer is engaged with the first subset of the plurality of posts and the second trim retainer is engaged with the second subset of the plurality of posts.
